(19) United States
(12) Patent Application Publication
(10) Pub. No.: US 2024/0231970 A9
(43) Pub. Date: Jul. 11, 2024

(54) SERVICE MANAGER ON A WEARABLE DEVICE

(71) Applicant: Snap Inc., Santa Monica, CA (US)

(72) Inventors: Adithya Gajulapally, Mountain View, CA (US); Piotr Gurgul, Hergiswil (CH); Andrew Ly, Playa Vista, CA (US); Sharon Moll, Lachen (CH)

(21) Appl. No.: 18/049,174

(22) Filed: Oct. 24, 2022

(51) Int. Cl. G06F 9/54; H04L 67/133

(52) U.S. Cl. CPC G06F 9/547; H04L 67/133

(57) ABSTRACT

Systems, methods, and computer readable media for a service manger to manage services on a wearable device are disclosed. The service manager remains active in memory and listens for requests for services. The service manager then determines which services to run and which to stop to respond to the requests for services. After running a service, the service manager calls the service to respond to the request and sends a response to the request to the sender of the request. The service manager may be resident on a different processor than a processor from which the requests for services originate. The service manager maintains priorities of the services to determine which services to stop or remove from memory.

### TECHNICAL FIELD

Examples of the present disclosure relate generally to a service manager that manages services and memory on a wearable device. More particularly, but not by way of limitation, examples of the present disclosure relate to a service manager that manages services on a wearable device by listening to requests for services, and then running, stopping, and calling the services to respond to the requests for the services.

### BACKGROUND

Users increasingly want virtual reality (VR), mixed reality (MR), and augmented reality (AR) wearable devices to operate in a more user-friendly manner with more functions. However, often, the wearable devices have limited memory and often the AR wearable devices have limited power to provide additional functions.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some nonlimiting examples are illustrated in the figures of the accompanying drawings in which:

FIG. 1 is a diagrammatic representation of a networked environment in which the present disclosure may be deployed, in accordance with some examples.

FIG. 2 is a diagrammatic representation of a messaging system, in accordance with some examples, that has both client-side and server-side functionality.

FIG. 3 is a diagrammatic representation of a data structure as maintained in a database, in accordance with some examples.

FIG. 4 is a diagrammatic representation of a message, in accordance with some examples.

FIG. 5 is a flowchart for an access-limiting process, in accordance with some examples.

FIG. 6 illustrates a system for a service manager on a wearable device, in accordance with some examples.

FIG. 7 illustrates a system for a service manager on a wearable device, in accordance with some examples.

FIG. 8 illustrates a system for a service manager on a wearable device, in accordance with some examples.

FIG. 9 illustrates a system for a service manager on a wearable device, in accordance with some examples.

FIG. 10 is a perspective view of a wearable electronic device in the form of glasses, in accordance with some examples.

FIG. 11 illustrates a method for a service manager on a wearable device, in accordance with some examples.

FIG. 12 is a diagrammatic representation of a machine in the form of a computer system within which a set of instructions may be executed for causing the machine to perform any one or more of the methodologies discussed herein, in accordance with some examples.

FIG. 13 is a block diagram showing a software architecture within which examples may be implemented.

FIG. 14 is a diagrammatic representation of a processing environment, in accordance with some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

The term AR wearable device is used as an illustrative device; however, one skilled in the art will recognize that the methods, systems, and computer readable medium disclosed herein are applicable to other wearable devices including non-AR wearable devices, VR wearable devices and MR wearable devices.

AR wearable devices 622 such as AR glasses 1000 have limited battery power and limited memory. Moreover, there are many services 626 that are provided by the operating system (OS) of the AR wearable device 622 such as a lock screen service 620, settings service 610, location service 612, and so forth. The services 626 are accessible from both applications operating on the AR wearable device 622 and applications that are operating outside the AR wearable device 622 such as a coupled client device 102 or a backend 644. For example, a backend 644 may call a settings service 610 to reset the settings, such as a display timeout, of the AR wearable device 622. Additionally, some operations 630 on the AR wearable device 622 such as bootup may require many services 626 but the memory 642 is limited.

One challenge is how to provide many services 626 with a limited memory and limited battery power. The challenge is addressed by a service manager 602 that listens for requests 634 for services 626 rather than the services 626 having to be active in memory to listen for the requests 634. The service manager 602 is responsible for running and stopping services 626 to manage the memory 642 usage and to respond to requests 634 for the services. The service manager 602 remains resident in memory 642. Moreover, the service manager 602 and the services 626 are run by the same processor, in accordance with some examples. Additionally, the service manager 602 uses priorities 628 assigned to the services 626 to determine which requests 634 for services 626 to respond to first and to determine which services 626 should be stopped first to reduce memory 642 usage. Moreover, the service manager 602 may determine that a current operation 630 is being performed by the AR wearable device 622 and make decisions regarding stopping and running services 626 based on the current operation 630. For example, a current operation 630 is capture an image. The send service 614 is used as part of the capture image operation 630 to send the image to a coupled client device 102 such as a coupled mobile phone. In this example, the service manager 602 determines to keep the send service 614 running and stops another service 626 because the current operation 630 of the AR wearable device 622 is to capture an image. In another example, another operation 630 is a bootup process for the AR wearable device 622, where the service manager 602 knows which services 626 are associated with the operation 630 such as the settings service 610 which provides all the initial settings for the AR wearable device 622.

Networked Computing Environment

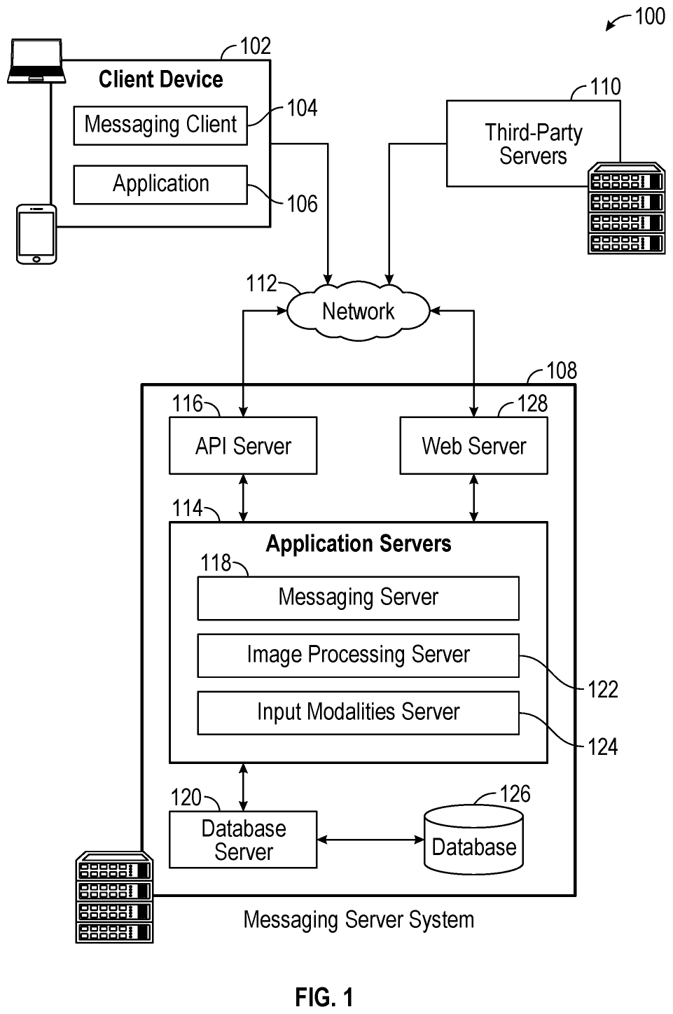

FIG. 1 is a block diagram showing an example messaging system 100 for exchanging data (e.g., messages and associated content) over a network. The messaging system 100 includes multiple instances of a client device 102, each of which hosts a number of applications, including a messaging client 104 and other applications 106. Each messaging client 104 is communicatively coupled to other instances of the messaging client 104 (e.g., hosted on respective other client devices 102), a messaging server system 108 and third-party servers 110 via a network 112 (e.g., the Internet). A messaging client 104 can also communicate with locally-hosted applications 106 using Applications Program Interfaces (APIs).

A messaging client 104 is able to communicate and exchange data with other messaging clients 104 and with the messaging server system 108 via the network 112. The data exchanged between messaging clients 104, and between a messaging client 104 and the messaging server system 108, includes functions (e.g., commands to invoke functions) as well as payload data (e.g., text, audio, video or other multimedia data).

The messaging server system 108 provides server-side functionality via the network 112 to a particular messaging client 104. While certain functions of the messaging system 100 are described herein as being performed by either a messaging client 104 or by the messaging server system 108, the location of certain functionality either within the messaging client 104 or the messaging server system 108 may be a design choice. For example, it may be technically preferable to initially deploy certain technology and functionality within the messaging server system 108 but to later migrate this technology and functionality to the messaging client 104 where a client device 102 has sufficient processing capacity.

The messaging server system 108 supports various services and operations that are provided to the messaging client 104. Such operations include transmitting data to, receiving data from, and processing data generated by the messaging client 104. This data may include message content, client device information, geolocation information, media augmentation and overlays, message content persistence conditions, social network information, and live event information, as examples. Data exchanges within the messaging system 100 are invoked and controlled through functions available via user interfaces (UIs) of the messaging client 104.

Turning now specifically to the messaging server system 108, an Application Program Interface (API) server 116 is coupled to, and provides a programmatic interface to, application servers 114. The application servers 114 are communicatively coupled to a database server 120, which facilitates access to a database 126 that stores data associated with messages processed by the application servers 114. Similarly, a web server 128 is coupled to the application servers 114, and provides web-based interfaces to the application servers 114. To this end, the web server 128 processes incoming network requests over the Hypertext Transfer Protocol (HTTP) and several other related protocols.

The Application Program Interface (API) server 116 receives and transmits message data (e.g., commands and message payloads) between the client device 102 and the application servers 114. Specifically, the Application Program Interface (API) server 116 provides a set of interfaces (e.g., routines and protocols) that can be called or queried by the messaging client 104 in order to invoke functionality of the application servers 114. The Application Program Interface (API) server 116 exposes various functions supported by the application servers 114, including account registration, login functionality, the sending of messages, via the application servers 114, from a particular messaging client 104 to another messaging client 104, the sending of media files (e.g., images or video) from a messaging client 104 to a messaging server 118, and for possible access by another messaging client 104, the settings of a collection of media data (e.g., story), the retrieval of a list of friends of a user of a client device 102, the retrieval of such collections, the retrieval of messages and content, the addition and deletion of entities (e.g., friends) to an entity graph (e.g., a social graph), the location of friends within a social graph, and opening an application event (e.g., relating to the messaging client 104).

The application servers 114 host a number of server applications and subsystems, including for example a messaging server 118, an image processing server 122, and an input modalities server 124. The messaging server 118 implements a number of message processing technologies and functions, particularly related to the aggregation and other processing of content (e.g., textual and multimedia content) included in messages received from multiple instances of the messaging client 104. As will be described in further detail, the text and media content from multiple sources may be aggregated into collections of content (e.g., called stories or galleries). These collections are then made available to the messaging client 104. Other processor and memory intensive processing of data may also be performed server-side by the messaging server 118, in view of the hardware requirements for such processing.

The application servers 114 also include an image processing server 122 that is dedicated to performing various image processing operations, typically with respect to images or video within the payload of a message sent from or received at the messaging server 118.

The input modalities server 124 supports input modalities for AR wearable devices. The input modalities server 124 receives requests from an AR wearable device and responds to the requests. The requests include sensor data such as an image being sent to the input modalities server 124 for processing. The input modalities server 124 processes the sensor data and identifies objects within the sensor data and returns names of the objects and positions of the objects within the sensor data to the AR wearable device. Another request from the AR wearable device is for AR applications associated with tags such as “QR code” that may be run on the AR wearable device. The input modalities server 124 may load the AR wearable device with AR applications that are likely to be used by a user of the AR wearable device or respond with AR applications based on criteria given to the input modalities server 124 from the AR wearable device. The criteria may be as a limit on the number of AR applications, preferences of the user such as AR applications with links back to the messaging system 100, and so forth.

Returning to the messaging client 104, features and functions of an external resource (e.g., an application 106 or applet) are made available to a user via an interface of the messaging client 104. In this context, “external” refers to the fact that the application 106 or applet is external to the messaging client 104. The external resource is often provided by a third party but may also be provided by the creator or provider of the messaging client 104. The messaging client 104 receives a user selection of an option to launch or access features of such an external resource. The external resource may be the application 106 installed on the client device 102 (e.g., a “native app”), or a small-scale version of the application (e.g., an “applet”) that is hosted on the client device 102 or remote of the client device 102 (e.g., on third-party servers 110). The small-scale version of the application includes a subset of features and functions of the application (e.g., the full-scale, native version of the application) and is implemented using a markup-language document. In one example, the small-scale version of the application (e.g., an “applet”) is a web-based, markup-language version of the application and is embedded in the messaging client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the messaging client 104 determines whether the selected external resource is a web-based external resource or a locally-installed application 106. In some cases, applications 106 that are locally installed on the client device 102 can be launched independently of and separately from the messaging client 104, such as by selecting an icon, corresponding to the application 106, on a home screen of the client device 102. Small-scale versions of such applications can be launched or accessed via the messaging client 104 and, in some examples, no or limited portions of the small-scale application can be accessed outside of the messaging client 104. The small-scale application can be launched by the messaging client 104 receiving, from a third-party server 110 for example, a markup-language document associated with the small-scale application and processing such a document.

In response to determining that the external resource is a locally-installed application 106, the messaging client 104 instructs the client device 102 to launch the external resource by executing locally-stored code corresponding to the external resource. In response to determining that the external resource is a web-based resource, the messaging client 104 communicates with the third-party servers 110 (for example) to obtain a markup-language document corresponding to the selected external resource. The messaging client 104 then processes the obtained markup-language document to present the web-based external resource within a user interface of the messaging client 104.

The messaging client 104 can notify a user of the client device 102, or other users related to such a user (e.g., “friends”), of activity taking place in one or more external resources. For example, the messaging client 104 can provide participants in a conversation (e.g., a chat session) in the messaging client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective messaging clients 104, with the ability to share an item, status, state, or location in an external resource with one or more members of a group of users into a chat session. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the messaging client 104. The external resource can selectively include different media items in the responses, based on a current context of the external resource.

The messaging client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

System Architecture

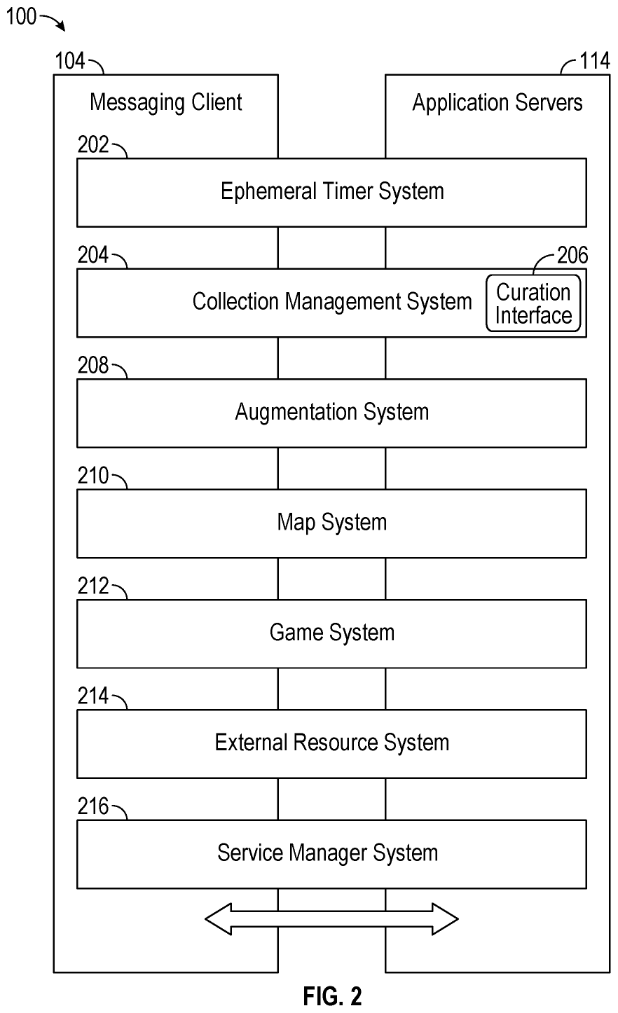

FIG. 2 is a block diagram illustrating further details regarding the messaging system 100, according to some examples. Specifically, the messaging system 100 is shown to comprise the messaging client 104 and the application servers 114. The messaging system 100 embodies a number of subsystems, which are supported on the client-side by the messaging client 104 and on the server-side by the application servers 114. These subsystems include, for example, an ephemeral timer system 202, a collection management system 204, an augmentation system 208, a map system 210, a game system 212, an external resource system 214, and a service manger system 216.

The ephemeral timer system 202 is responsible for enforcing the temporary or time-limited access to content by the messaging client 104 and the messaging server 118. The ephemeral timer system 202 incorporates a number of timers that, based on duration and display parameters associated with a message, or collection of messages (e.g., a story), selectively enable access (e.g., for presentation and display) to messages and associated content via the messaging client 104. Further details regarding the operation of the ephemeral timer system 202 are provided below.

The collection management system 204 is responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client 104.

The collection management system 204 furthermore includes a curation interface 206 that allows a collection manager to manage and curate a particular collection of content. For example, the curation interface 206 enables an event organizer to curate a collection of content relating to a specific event (e.g., delete inappropriate content or redundant messages). Additionally, the collection management system 204 employs machine vision (or image recognition technology) and content rules to automatically curate a content collection. In certain examples, compensation may be paid to a user for the inclusion of user-generated content into a collection. In such cases, the collection management system 204 operates to automatically make payments to such users for the use of their content.

The augmentation system 208 provides various functions that enable a user to augment (e.g., annotate or otherwise modify or edit) media content associated with a message. For example, the augmentation system 208 provides functions related to the generation and publishing of media overlays for messages processed by the messaging system 100. The augmentation system 208 operatively supplies a media overlay or augmentation (e.g., an image filter) to the messaging client 104 based on a geolocation of the client device 102. In another example, the augmentation system 208 operatively supplies a media overlay to the messaging client 104 based on other information, such as social network information of the user of the client device 102. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo, a digital object) at the client device 102. For example, the media overlay may include text or image that can be overlaid on top of a photograph taken by the client device 102. In another example, the media overlay includes an identification of a location overlay (e.g., Venice beach), a name of a live event, or a name of a merchant overlay (e.g., Beach Coffee House). In another example, the augmentation system 208 uses the geolocation of the client device 102 to identify a media overlay that includes the name of a merchant at the geolocation of the client device 102. The media overlay may include other indicia associated with the merchant. The media overlays may be stored in the database 126 and accessed through the database server 120.

In some examples, the augmentation system 208 provides a user-based publication platform that enables users to select a geolocation on a map and upload content associated with the selected geolocation. The user may also specify circumstances under which a particular media overlay should be offered to other users. The augmentation system 208 generates a media overlay that includes the uploaded content and associates the uploaded content with the selected geolocation.

In other examples, the augmentation system 208 provides a merchant-based publication platform that enables merchants to select a particular media overlay associated with a geolocation via a bidding process. For example, the augmentation system 208 associates the media overlay of the highest bidding merchant with a corresponding geolocation for a predefined amount of time.

The map system 210 provides various geographic location functions and supports the presentation of map-based media content and messages by the messaging client 104. For example, the map system 210 enables the display of user icons or avatars (e.g., stored in profile data 316) on a map to indicate a current or past location of “friends” of a user, as well as media content (e.g., collections of messages including photographs and videos) generated by such friends, within the context of a map. For example, a message posted by a user to the messaging system 100 from a specific geographic location may be displayed within the context of a map at that particular location to “friends” of a specific user on a map interface of the messaging client 104. A user can furthermore share his or her location and status information (e.g., using an appropriate status avatar) with other users of the messaging system 100 via the messaging client 104, with this location and status information being similarly displayed within the context of a map interface of the messaging client 104 to selected users.

The game system 212 provides various gaming functions within the context of the messaging client 104. The messaging client 104 provides a game interface providing a list of available games that can be launched by a user within the context of the messaging client 104 and played with other users of the messaging system 100. The messaging system 100 further enables a particular user to invite other users to participate in the play of a specific game, by issuing invitations to such other users from the messaging client 104. The messaging client 104 also supports both voice and text messaging (e.g., chats) within the context of gameplay, provides a leaderboard for the games, and also supports the provision of in-game rewards (e.g., coins and items).

The external resource system 214 provides an interface for the messaging client 104 to communicate with remote servers (e.g., third-party servers 110) to launch or access external resources, e.g., applications or applets. Each third-party server 110 hosts, for example, a markup language (e.g., HTML5) based application or small-scale version of an application (e.g., game, utility, payment, or ride-sharing application). The messaging client 104 may launch a web-based resource (e.g., application) by accessing the HTML5 file from the third-party servers 110 associated with the web-based resource. In certain examples, applications hosted by third-party servers 110 are programmed in JavaScript leveraging a Software Development Kit (SDK) provided by the messaging server 118. The SDK includes Application Programming Interfaces (APIs) with functions that can be called or invoked by the web-based application. In certain examples, the messaging server 118 includes a JavaScript library that provides a given external resource access to certain user data of the messaging client 104. HTML5 is used as an example technology for programming games, but applications and resources programmed based on other technologies can be used.

In order to integrate the functions of the SDK into the web-based resource, the SDK is downloaded by a third-party server 110 from the messaging server 118 or is otherwise received by the third-party server 110. Once downloaded or received, the SDK is included as part of the application code of a web-based external resource. The code of the web-based resource can then call or invoke certain functions of the SDK to integrate features of the messaging client 104 into the web-based resource.

The SDK stored on the messaging server 118 effectively provides the bridge between an external resource (e.g., applications 106 or applets and the messaging client 104. This provides the user with a seamless experience of communicating with other users on the messaging client 104, while also preserving the look and feel of the messaging client 104. To bridge communications between an external resource and a messaging client 104, in certain examples, the SDK facilitates communication between third-party servers 110 and the messaging client 104. In certain examples, a Web ViewJavaScriptBridge running on a client device 102 establishes two one-way communication channels between an external resource and the messaging client 104. Messages are sent between the external resource and the messaging client 104 via these communication channels asynchronously. Each SDK function invocation is sent as a message and callback. Each SDK function is implemented by constructing a unique callback identifier and sending a message with that callback identifier.

By using the SDK, not all information from the messaging client 104 is shared with third-party servers 110. The SDK limits which information is shared based on the needs of the external resource. In certain examples, each third-party server 110 provides an HTML5 file corresponding to the web-based external resource to the messaging server 118. The messaging server 118 can add a visual representation (such as a box art or other graphic) of the web-based external resource in the messaging client 104. Once the user selects the visual representation or instructs the messaging client 104 through a GUI of the messaging client 104 to access features of the web-based external resource, the messaging client 104 obtains the HTML5 file and instantiates the resources necessary to access the features of the web-based external resource.

The messaging client 104 presents a graphical user interface (e.g., a landing page or title screen) for an external resource. During, before, or after presenting the landing section of reading materials such as a page or title screen, the messaging client 104 determines whether the launched external resource has been previously authorized to access user data of the messaging client 104. In response to determining that the launched external resource has been previously authorized to access user data of the messaging client 104, the messaging client 104 presents another graphical user interface of the external resource that includes functions and features of the external resource. In response to determining that the launched external resource has not been previously authorized to access user data of the messaging client 104, after a threshold period of time (e.g., 3 seconds) of displaying the landing page or title screen of the external resource, the messaging client 104 slides up (e.g., animates a menu as surfacing from a bottom of the screen to a middle of or other portion of the screen) a menu for authorizing the external resource to access the user data. The menu identifies the type of user data that the external resource will be authorized to use. In response to receiving a user selection of an accept option, the messaging client 104 adds the external resource to a list of authorized external resources and allows the external resource to access user data from the messaging client 104. In some examples, the external resource is authorized by the messaging client 104 to access the user data in accordance with an OAuth 2 framework.

The messaging client 104 controls the type of user data that is shared with external resources based on the type of external resource being authorized. For example, external resources that include full-scale applications (e.g., an application 106) are provided with access to a first type of user data (e.g., only two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

The service manager system 216 supports AR wearable device 622 and may make requests 634 for the services 626 of the AR wearable device 622. The requests 634 include a remote procedure call (RPC) to a setting service 610. For example, the service manager system 216 sends an RPC request 634 to the AR wearable device 622 to reset one or more parameters such as a display timeout parameter. The service manager system 216 may facilitate communication between the client device 102 and the AR wearable device 622 by providing store and forward services for messages between the client device 102 and the AR wearable device 622.

Data Architecture

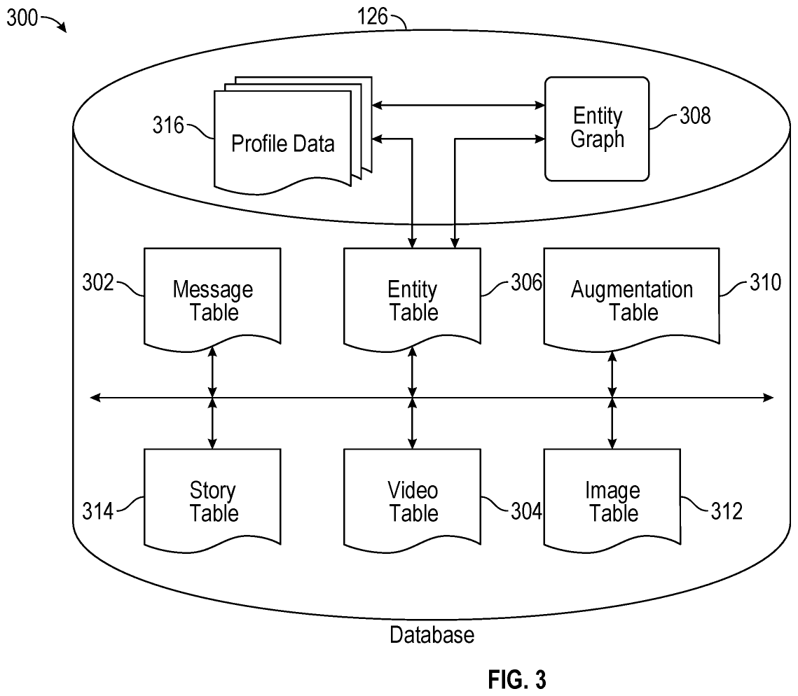

FIG. 3 is a schematic diagram illustrating data structures 300, which may be stored in the database 126 of the messaging server system 108, according to certain examples. While the content of the database 126 is shown to comprise a number of tables, it will be appreciated that the data could be stored in other types of data structures (e.g., as an object-oriented database).

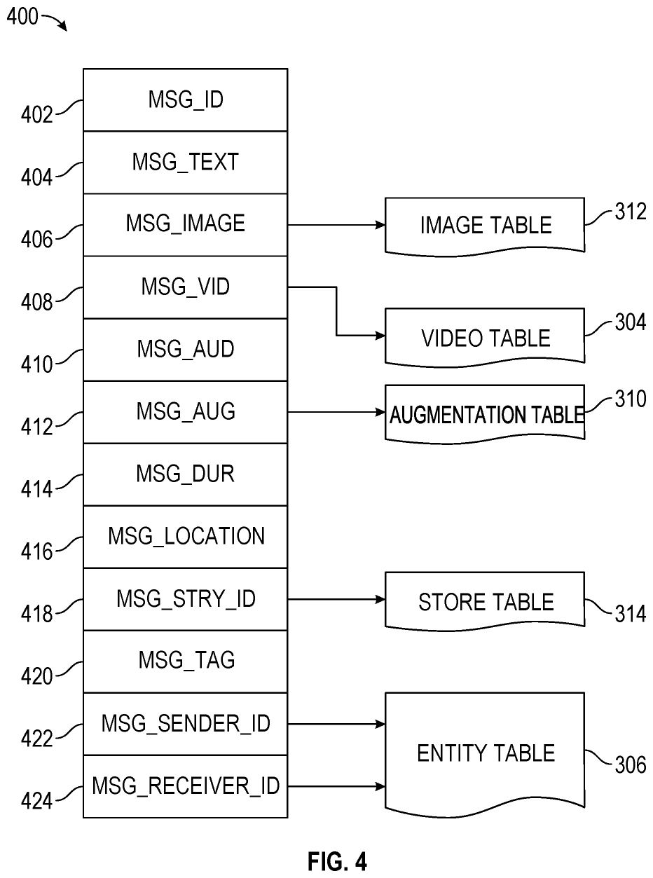

The database 126 includes message data stored within a message table 302. This message data includes, for any particular one message, at least message sender data, message recipient (or receiver) data, and a payload. Further details regarding information that may be included in a message, and included within the message data stored in the message table 302 is described below with reference to FIG. 4.

An entity table 306 stores entity data, and is linked (e.g., referentially) to an entity graph 308 and profile data 316. Entities for which records are maintained within the entity table 306 may include individuals, corporate entities, organizations, objects, places, events, and so forth. Regardless of entity type, any entity regarding which the messaging server system 108 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization) interested-based or activity-based, merely for example.

The profile data 316 stores multiple types of profile data about a particular entity. The profile data 316 may be selectively used and presented to other users of the messaging system 100, based on privacy settings specified by a particular entity. Where the entity is an individual, the profile data 316 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the messaging system 100, and on map interfaces displayed by messaging clients 104 to other users. The collection of avatar representations may include “status avatars,” which present a graphical representation of a status or activity that the user may select to communicate at a particular time.

Where the entity is a group, the profile data 316 for the group may similarly include one or more avatar representations associated with the group, in addition to the group name, members, and various settings (e.g., notifications) for the relevant group.

The database 126 also stores augmentation data, such as overlays or filters, in an augmentation table 310. The augmentation data is associated with and applied to videos (for which data is stored in a video table 304) and images (for which data is stored in an image table 312).

Filters, in one example, are overlays that are displayed as overlaid on an image or video during presentation to a recipient user. Filters may be of various types, including user-selected filters from a set of filters presented to a sending user by the messaging client 104 when the sending user is composing a message. Other types of filters include geolocation filters (also known as geo-filters), which may be presented to a sending user based on geographic location. For example, geolocation filters specific to a neighborhood or special location may be presented within a user interface by the messaging client 104, based on geolocation information determined by a Global Positioning System (GPS) unit of the client device 102.

Another type of filter is a data filter, which may be selectively presented to a sending user by the messaging client 104, based on other inputs or information gathered by the client device 102 during the message creation process. Examples of data filters include current temperature at a specific location, a current speed at which a sending user is traveling, battery life for a client device 102, or the current time.

Other augmentation data that may be stored within the image table 312 includes augmented reality content items (e.g., corresponding to applying Lenses or augmented reality experiences). An augmented reality content item may be a real-time special effect and sound that may be added to an image or a video.

As described above, augmentation data includes augmented reality content items, overlays, image transformations, AR images, and similar terms refer to modifications that may be applied to image data (e.g., videos or images). This includes real-time modifications, which modify an image as it is captured using device sensors (e.g., one or multiple cameras) of a client device 102 and then displayed on a screen of the client device 102 with the modifications. This also includes modifications to stored content, such as video clips in a gallery that may be modified. For example, in a client device 102 with access to multiple augmented reality content items, a user can use a single video clip with multiple augmented reality content items to see how the different augmented reality content items will modify the stored clip. For example, multiple augmented reality content items that apply different pseudorandom movement models can be applied to the same content by selecting different augmented reality content items for the content. Similarly, real-time video capture may be used with an illustrated modification to show how video images currently being captured by sensors of a client device 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects, and using transformations and animated textures of the model within the video to achieve the transformation. In other examples, tracking of points on an object may be used to place an image or texture (which may be two dimensional or three dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated (e.g., using an Active Shape Model (ASM) or other known methods). Then, a mesh based on the characteristic points is generated for each of the at least one element of the object. This mesh is used in the following stage of tracking the elements of the object in the video stream. In the process of tracking, the mentioned mesh for each element is aligned with a position of each element. Then, additional points are generated on the mesh. A first set of first points is generated for each element based on a request for modification, and a set of second points is generated for each element based on the set of first points and the request for modification. Then, the frames of the video stream can be transformed by modifying the elements of the object on the basis of the sets of first and second points and the mesh. In such method, a background of the modified object can be changed or distorted as well by tracking and modifying the background.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing color of areas; removing at least some part of areas from the frames of the video stream; including one or more new objects into areas which are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image with use of a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

In some examples, a search for landmarks from the mean shape aligned to the position and size of the face determined by a global face detector is started. Such a search then repeats the steps of suggesting a tentative shape by adjusting the locations of shape points by template matching of the image texture around each point and then conforming the tentative shape to a global shape model until convergence occurs. In some systems, individual template matches are unreliable, and the shape model pools the results of the weak template matches to form a stronger overall classifier. The entire search is repeated at each level in an image pyramid, from coarse to fine resolution.

A transformation system can capture an image or video stream on a client device (e.g., the client device 102) and perform complex image manipulations locally on the client device 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the client device 102.

In some examples, a computer animation model to transform image data can be used by a system where a user may capture an image or video stream of the user (e.g., a selfie) using a client device 102 having a neural network operating as part of a messaging client 104 operating on the client device 102. The transformation system operating within the messaging client 104 determines the presence of a face within the image or video stream and provides modification icons associated with a computer animation model to transform image data, or the computer animation model can be present as associated with an interface described herein. The modification icons include changes that may be the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the client device 102 as soon as the image or video stream is captured, and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browse to other areas of the imaging application. Where multiple faces are modified by the transformation system, the user may toggle the modification on or off globally by tapping or selecting a single face modified and displayed within a graphical user interface. In some examples, individual faces, among a group of multiple faces, may be individually modified, or such modifications may be individually toggled by tapping or selecting the individual face or a series of individual faces displayed within the graphical user interface.

A story table 314 stores data regarding collections of messages and associated image, video, or audio data, which are compiled into a collection (e.g., a story or a gallery). The creation of a particular collection may be initiated by a particular user (e.g., each user for which a record is maintained in the entity table 306). A user may create a “personal story” in the form of a collection of content that has been created and sent/broadcast by that user. To this end, the user interface of the messaging client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from varies locations and events. Users whose client devices have location services enabled and are at a common location event at a particular time may, for example, be presented with an option, via a user interface of the messaging client 104, to contribute content to a particular live story. The live story may be identified to the user by the messaging client 104, based on his or her location. The end result is a “live story” told from a community perspective.

A further type of content collection is known as a “location story,” which enables a user whose client device 102 is located within a specific geographic location (e.g., on a college or university campus) to contribute to a particular collection. In some examples, a contribution to a location story may require a second degree of authentication to verify that the end-user belongs to a specific organization or other entity (e.g., is a student on the university campus).

As mentioned above, the video table 304 stores video data that, in one example, is associated with messages for which records are maintained within the message table 302. Similarly, the image table 312 stores image data associated with messages for which message data is stored in the entity table 306. The entity table 306 may associate various augmentations from the augmentation table 310 with various images and videos stored in the image table 312 and the video table 304.

Data Communications Architecture

FIG. 4 is a schematic diagram illustrating a structure of a message 400, according to some examples, generated by a messaging client 104 for communication to a further messaging client 104 or the messaging server 118. The content of a particular message 400 is used to populate the message table 302 stored within the database 126, accessible by the messaging server 118. Similarly, the content of a message 400 is stored in memory as “in-transit” or “in-flight” data of the client device 102 or the application servers 114. A message 400 is shown to include the following example components:
message identifier 402: a unique identifier that identifies the message 400.
message text payload 404: text, to be generated by a user via a user interface of the client device 102, and that is included in the message 400.
message image payload 406: image data, captured by a camera component of a client device 102 or retrieved from a memory component of a client device 102, and that is included in the message 400. Image data for a sent or received message 400 may be stored in the image table 312.
message video payload 408: video data, captured by a camera component or retrieved from a memory component of the client device 102, and that is included in the message 400. Video data for a sent or received message 400 may be stored in the video table 304.
message audio payload 410: audio data, captured by a microphone or retrieved from a memory component of the client device 102, and that is included in the message 400.
message augmentation data 412: augmentation data (e.g., filters, stickers, or other annotations or enhancements) that represents augmentations to be applied to message image payload 406, message video payload 408, or message audio payload 410 of the message 400. Augmentation data for a sent or received message 400 may be stored in the augmentation table 310.
message duration parameter 414: parameter value indicating, in seconds, the amount of time for which content of the message (e.g., the message image payload 406, message video payload 408, message audio payload 410) is to be presented or made accessible to a user via the messaging client 104.
message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image into within the message image payload 406, or a specific video in the message video payload 408).
message story identifier 418: identifier values identifying one or more content collections (e.g., “stories” identified in the story table 314) with which a particular content item in the message image payload 406 of the message 400 is associated. For example, multiple images within the message image payload 406 may each be associated with multiple content collections using identifier values.
message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
message sender identifier 422: an identifier (e.g., a messaging system identifier, email address, or device identifier) indicative of a user of the Client device 102 on which the message 400 was generated and from which the message 400 was sent.
message receiver identifier 424: an identifier (e.g., a messaging system identifier, email address, or device identifier) indicative of a user of the client device 102 to which the message 400 is addressed.

The contents (e.g., values) of the various components of message 400 may be pointers to locations in tables within which content data values are stored. For example, an image value in the message image payload 406 may be a pointer to (or address of) a location within an image table 312. Similarly, values within the message video payload 408 may point to data stored within a video table 304, values stored within the message augmentations 412 may point to data stored in an augmentation table 310, values stored within the message story identifier 418 may point to data stored in a story table 314, and values stored within the message sender identifier 422 and the message receiver identifier 424 may point to user records stored within an entity table 306.

Time-Based Access Limitation Architecture

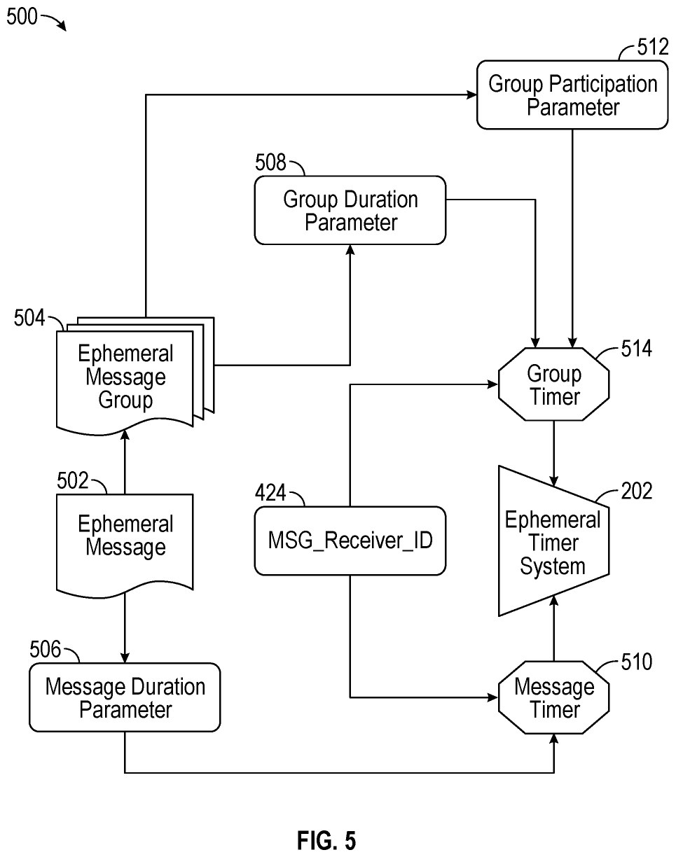

FIG. 5 is a schematic diagram illustrating an access-limiting process 500, in terms of which access to content (e.g., an ephemeral message 502, and associated multimedia payload of data) or a content collection (e.g., an ephemeral message group 504) may be time-limited (e.g., made ephemeral).

An ephemeral message 502 is shown to be associated with a message duration parameter 506, the value of which determines an amount of time that the ephemeral message 502 will be displayed to a receiving user of the ephemeral message 502 by the messaging client 104. In one example, an ephemeral message 502 is viewable by a receiving user for up to a maximum of 10 seconds, depending on the amount of time that the sending user specifies using the message duration parameter 506.

The message duration parameter 506 and the message receiver identifier 424 are shown to be inputs to a message timer 510, which is responsible for determining the amount of time that the ephemeral message 502 is shown to a particular receiving user identified by the message receiver identifier 424. In particular, the ephemeral message 502 will only be shown to the relevant receiving user for a time period determined by the value of the message duration parameter 506. The message timer 510 is shown to provide output to a more generalized ephemeral timer system 202, which is responsible for the overall timing of display of content (e.g., an ephemeral message 502) to a receiving user.

The ephemeral message 502 is shown in FIG. 5 to be included within an ephemeral message group 504 (e.g., a collection of messages in a personal story, or an event story). The ephemeral message group 504 has an associated group duration parameter 508, a value of which determines a time duration for which the ephemeral message group 504 is presented and accessible to users of the messaging system 100. The group duration parameter 508, for example, may be the duration of a music concert, where the ephemeral message group 504 is a collection of content pertaining to that concert. Alternatively, a user (either the owning user or a curator user) may specify the value for the group duration parameter 508 when performing the setup and creation of the ephemeral message group 504.

Additionally, each ephemeral message 502 within the ephemeral message group 504 has an associated group participation parameter 512, a value of which determines the duration of time for which the ephemeral message 502 will be accessible within the context of the ephemeral message group 504. Accordingly, a particular ephemeral message group 504 may “expire” and become inaccessible within the context of the ephemeral message group 504, prior to the ephemeral message group 504 itself expiring in terms of the group duration parameter 508. The group duration parameter 508, group participation parameter 512, and message receiver identifier 424 each provide input to a group timer 514, which operationally determines, firstly, whether a particular ephemeral message 502 of the ephemeral message group 504 will be displayed to a particular receiving user and, if so, for how long. Note that the ephemeral message group 504 is also aware of the identity of the particular receiving user as a result of the message receiver identifier 424.

Accordingly, the group timer 514 operationally controls the overall lifespan of an associated ephemeral message group 504, as well as an individual ephemeral message 502 included in the ephemeral message group 504. In one example, each and every ephemeral message 502 within the ephemeral message group 504 remains viewable and accessible for a time period specified by the group duration parameter 508. In a further example, a certain ephemeral message 502 may expire, within the context of ephemeral message group 504, based on a group participation parameter 512. Note that a message duration parameter 506 may still determine the duration of time for which a particular ephemeral message 502 is displayed to a receiving user, even within the context of the ephemeral message group 504. Accordingly, the message duration parameter 506 determines the duration of time that a particular ephemeral message 502 is displayed to a receiving user, regardless of whether the receiving user is viewing that ephemeral message 502 inside or outside the context of an ephemeral message group 504.

The ephemeral timer system 202 may furthermore operationally remove a particular ephemeral message 502 from the ephemeral message group 504 based on a determination that it has exceeded an associated group participation parameter 512. For example, when a sending user has established a group participation parameter 512 of 24 hours from posting, the ephemeral timer system 202 will remove the relevant ephemeral message 502 from the ephemeral message group 504 after the specified 24 hours. The ephemeral timer system 202 also operates to remove an ephemeral message group 504 when either the group participation parameter 512 for each and every ephemeral message 502 within the ephemeral message group 504 has expired, or when the ephemeral message group 504 itself has expired in terms of the group duration parameter 508.

In certain use cases, a creator of a particular ephemeral message group 504 may specify an indefinite group duration parameter 508. In this case, the expiration of the group participation parameter 512 for the last remaining ephemeral message 502 within the ephemeral message group 504 will determine when the ephemeral message group 504 itself expires. In this case, a new ephemeral message 502, added to the ephemeral message group 504, with a new group participation parameter 512, effectively extends the life of an ephemeral message group 504 to equal the value of the group participation parameter 512.

Responsive to the ephemeral timer system 202 determining that an ephemeral message group 504 has expired (e.g., is no longer accessible), the ephemeral timer system 202 communicates with the messaging system 100 (and, for example, specifically the messaging client 104) to cause an indicium (e.g., an icon) associated with the relevant ephemeral message group 504 to no longer be displayed within a user interface of the messaging client 104. Similarly, when the ephemeral timer system 202 determines that the message duration parameter 506 for a particular ephemeral message 502 has expired, the ephemeral timer system 202 causes the messaging client 104 to no longer display an indicium (e.g., an icon or textual identification) associated with the ephemeral message 502.

Service Manager on a Wearable Device

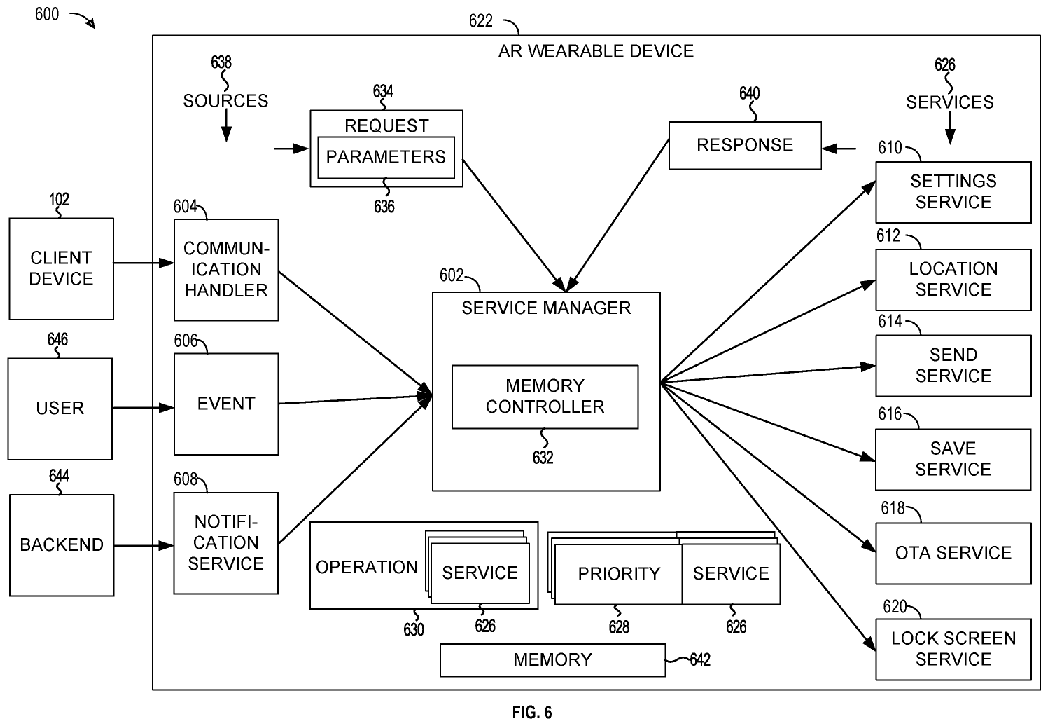

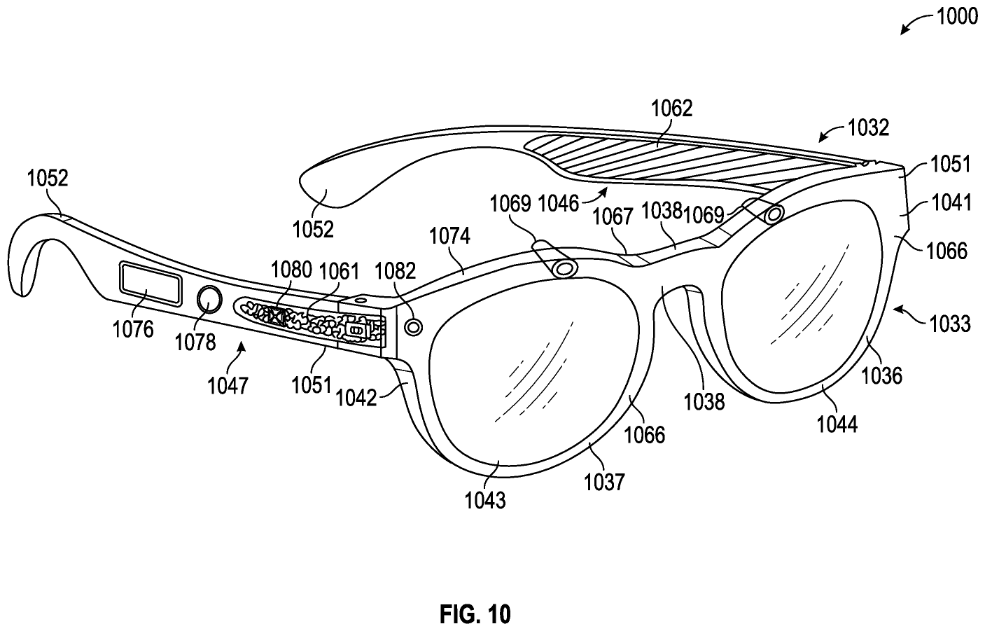

FIG. 6 illustrates a system 600 for a service manager 602 on a wearable device, in accordance with some examples. The system 600 includes an AR wearable device 622 such as glasses 1000 of FIG. 10 and may include other devices such as a portion of the messaging server system 108, and/or the client device 102, that may perform one or more of the operations described herein. In accordance with some examples, the AR wearable device 622 is another type of wearable device such a watch, MR wearable device, or VR wearable device.

The service manager 602 takes requests 634 for services 626 from sources 638 and runs the service 626 if it is not running and passes the request 634 to the service 626 that is indicated by the request 634. The request 634 may include parameters 636. The service 626 may return a response 640, which the service manager 602 returns to the corresponding source 638. A source 638 may run on different processor of the AR wearable device 622 than the service manager 602 is running on.

Additionally, the request 634 may originate from outside the AR wearable device 622. For example, the requests 634 may originate from a client device 102 such as a paired mobile phone. The client device 102 generates the request 634 and sends it to the AR wearable device 622 via the communication handler 604. Examples of the communication handler 604 are the BLE RPC handler 710 and a handler for the HTTP 804. The communication handler 604 may be configured to perform communication protocols such as BLE, 3GPP, proprietary protocols, and so forth.

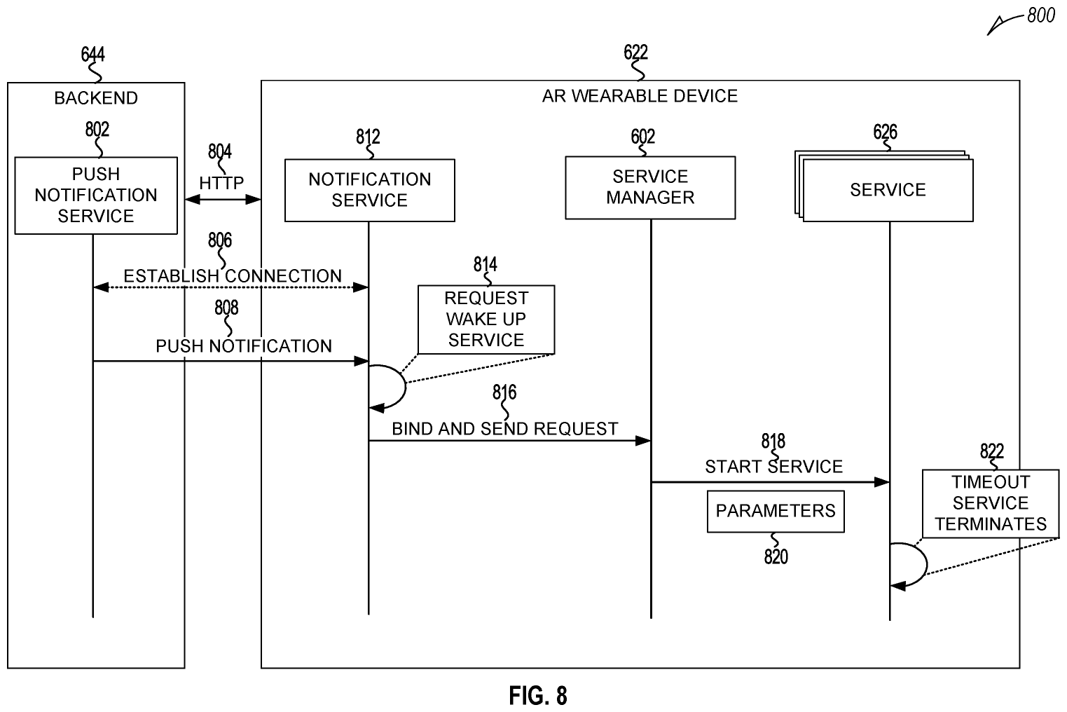

The user 646 or changes in the state of the AR wearable device 622 generate events 606 that generate requests 634, in accordance with some examples. For example, the user 646 may interact with a user interface to select a function that requires a service 626 such as taking a photograph or image. A change in state such as a timeout of the AR wearable device 622 may request a service 626 such as a lock screen service 620. The backend 644 may generate requests 634 that are processed by the notification service 608. For example, the backend 644 is the messaging service system 108 and the notification service 608 is notification service 812 of FIG. 8. The backend 644 may communicate with the AR wearable device 622 directly or indirectly via the client device 102 and one or more other devices.

The service manager 602 listens for the requests 634 rather than the services 626 listening for the requests 634. The services 626 then do not need to be running in a memory 642 of the AR wearable device 622. The memory 642 may be limited and not large enough to accommodate all the services 626 running at the same time. Additionally, the services 626 running on the AR wearable device 622 use power when running and the AR wearable device 622 often is powered by batteries.

The sources 638 include a settings service 610, a location service 612, a send service 614, a save service 616, an over-the-air (OTA) service 618, a lock screen service 620, and so forth. The number of sources 638 may be twenty or more. The services 626 may have a priority 628. Table 1 “Priority of Service” illustrates an example of priorities 628 assigned to the services 626 where a higher number indicates a higher priority. The priority 628 is used by the service manager 602 to determine which services 626 to run, stop, or reduce its memory 642.

TABLE 1
Priority of Service

| Service 626 | Priority of Service 628 |
|---|---|
| Send | 6 |
| Telemetry | 10 |
| COF | 5 |
| Media | 6 |
| Account | 10 |
| Manager | 10 |
| Capture | 0 |
| Sound | 1 |
| Notification | 4 |
| Connector | 7 |
| OTA | 0 |
| Camera | 8 |
| Lockscreen | 2 |
| Audio Input | 0 |

In some examples, an operation 630 is associated with one or more services 626. For example, when a user 646 captures an image, the OTA service 618 and/or the send service 614 may be used in conjunction with a service to capture the image. The service manager 602 may use the association of the operation 630 with one or more services 626 to determine which service 626 to run, stop, or reduce its memory 642.

The memory controller 632 responds to trim memory 902 requests from an operating system (OS) of the AR wearable device 622 or the service manager 602. The memory controller 632 may trim the memory 642 usage of services 626 without requests from the OS. The memory controller 632 may use the priority 628 of the service 626 to determine which service 626 to trim memory 642 and/or to determine the level of resources the service 626 should trim. The memory controller 632 may use a current or pending operation 630 to determine which service 626 to trim memory 642 and/or to determine the level of resources the service 626 should trim.

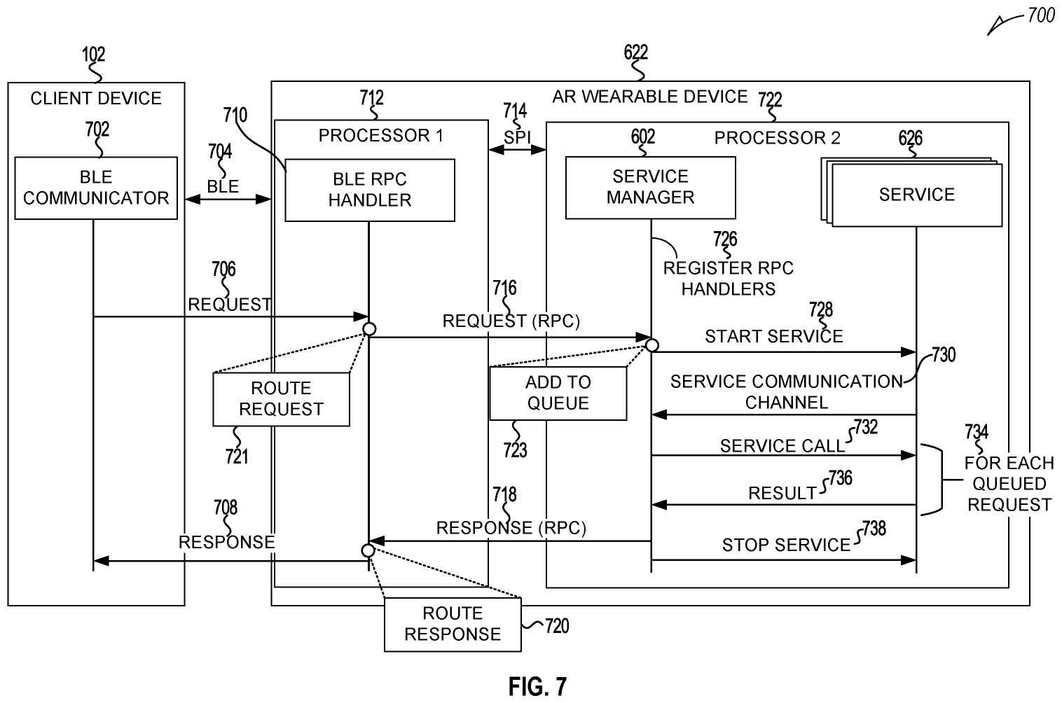

FIG. 7 illustrates a system 700 for a service manager 602 on a wearable device, in accordance with some examples. A client device 102 includes a low-energy Bluetooth (BLE®) communicator 702. The BLE communicator 702 and the BLE remote procedure call (RPC) handler 710 of processor 1 712 communicate with one another via BLE 704. In some examples, the BLE communicator 702 and the BLE RCP handler 710 have authenticated one another. The client device 102, which may be a paired mobile phone, is requesting 706 a service 626. The BLE RPC handler 710 receives the request 706 and routes request 721 by determining to send the request (RPC) 716 to the service manager 602 residing on processor 2 722. The request (RPC) 716 is sent to the service manager 602. For example, the request (RPC) 716 may be sent over a Serial Peripheral Interface (SPI) 714 connecting processor 1 712 and processor 2 722. Processor 1 712 and processor 2 722 may be connected in a different way. The service manger 602 had registered RPC handlers 726 to handle the request (RPC) 716. The service manager 602 adds to queue 723 the request (RPC) 716. The request (RPC) 716 is requesting a service 626. The service manager 602 may organize the queue in accordance with a priority 628 of a service 626. The service manager 602 selects a service 626 to start or run from the queue based on the priority 628, operation 630, and whether the service 626 is running or not.

The service manger 602 starts service 728 if the service 626 is not running. In some examples, other services 626 are stopped to make room for the service 626 in the memory 642. In some examples, the memory controller 632 calls one or more other services 626 to reduce their memory 642 usage to accommodate the service 626 indicated in the request (RPC) 716.

The service 626 indicates that it is running by sending a service communication 730 over a channel. The service manager 602 responds by making the service call 732 indicated in the request (RPC) 716. The service 626 performs the RPC and sends a result 736. As an example, the RPC was a command to lock the screen of the AR wearable device 622. The lock screen service 620 locks the screen in response to the service call 732 and returns a result 736. The result 736 may include parameters such as an indication that the screen was successfully locked. The service manager 602 may have queued up more than one request (RPC) 716 to the service 626. The service manager 602 may then for each queued request 734 send the service call 732 and receive the result 736. In some examples, the service manager 602 determines to add to queue 723 a request (RPC) 716 or another request if a status of the service 626 indicates it is not running, and the service manager 602 determines that there is not enough memory 642 to run the service 626. The service manager 602 may determine that the service 626 is not critical and that the current running services 626 are more important or have a higher priority 628. In some examples, the service manager 602 determines that an operation 630 is currently being performed by the AR wearable device 622 such as capturing an image and that the service 626 can wait to be run until after the operation 630 of capturing the image is completed.

The service manager 602, optionally, sends a stop service 738. The service 626 may be stopped based on other requests (RPC) 716 for other services and based on a priority 628 of the service 626. Additionally, the service manager 602 may determine to stop the service 626 or not based on a current operation 630. The service manager 602 may determine to stop the service 626 because it is infrequently requested and because allowing the service 626 to remain active consumes memory 642 and battery power.

The service manager 602 sends the response (RPC) 718 to the BLE RPC handler 710. The BLE RPC handler 710 determines how to route response 720. The BLE RPC handler 710 sends the response 708 to the BLE communicator 702 where the response 708 may include any parameters associated with the result 736. The request 706 is an example of request 634, and response 708 is an example of the response 640.

FIG. 8 illustrates a system 800 for a service manager 602 on a wearable device, in accordance with some examples. The AR wearable device 622 and backend 644 establish connection 806 via HTTP 804, which may include authentication and where there may be one or more intermediate devices that forward or route the HTTP 804.

The backend 644 includes a push notification service 802. The push notification service 802 can send requests for services 626 to be started on the AR wearable device 622. For example, the backend 644 sends a push notification 808 that includes a request to start or wake-up a settings service 610, where the setting service 610 enables the backend 644 to reset or set settings of the AR wearable device 622. In some examples, the client device 102 includes a push notification service 802.

The notification service 812 on the AR wearable device 622 receives the push notification 808 and processes the request wake up service 814. The notification service 812 determines that the service 626 is available on the AR wearable device 622. The notification service 812 sends a bind and send request 816, which indicates the service 626, to the service manager 602. The service manager 602 sends a start service 818 if the service 626 is not running with parameters 820 that may have been included in the push notification 808. The service 626 is awakened or run. The service 626 may return an indication that it is active, which may be sent back to the backend 644 via the service manager 602 and the notification service 812. The service 626 may timeout at timeout service terminates 822. In some examples, the service manager 602 sends a command to the service 626 to terminate if the service 626 remains inactive for greater than or transgresses a threshold period of time. The push notification 808 is an example of a request 634.

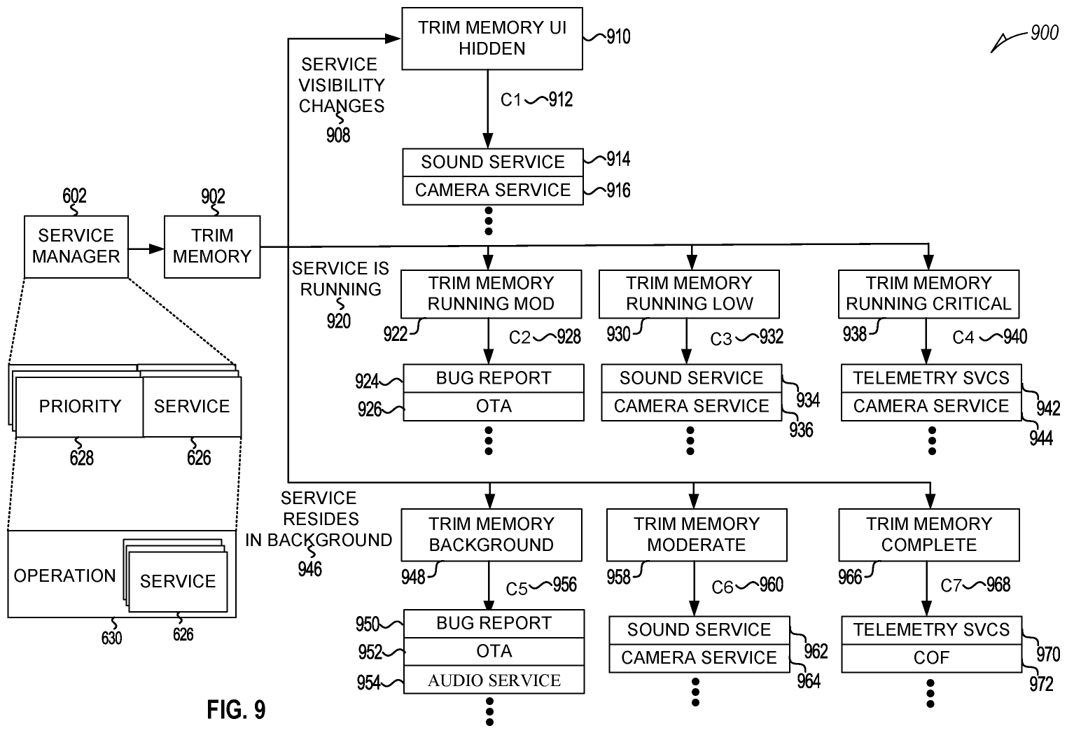

FIG. 9 illustrates a system 900 for a service manager 602 on a wearable device, in accordance with some examples. The service manager 602 may trim memory 902 for one or more services 626 to manage the memory 642 usage based on the system 900. In some examples, the service manager 602 receives a trim memory 902 signal from the OS for memory 642 to be trimmed. Trimming memory is an operation where for the service manager 602 it means to stop services 626 and/or to signal to one or more services 626 to reduce their memory 642 usage. For example, a signal to trim memory to a send service 614 may mean to release memory 642 that was used for buffering input and output messages. Often, services 626 may use memory 642 for operation that can be released. The service 626 is still considered to be running but it has reduced its memory 642 usage and may have to request additional memory 642 to service calls to the service 626. Additionally, the service manager 602 stopping a service 626 indicates it is removed from memory 642. The OS additionally may remove tables or data associated with the service 626 when the service 626 is stopped. The service manager 602 running a service 626 indicates the service 626 is resident in memory 642 and may be called or signaled to perform a service to which it is configured to perform. The services 626 and the service manger 602 run on the same processor or set of processors, in accordance with some embodiments. The service manger 602 remains resident in memory 642 to catch the signals for the services 626.

The service manager 602 may base decisions on the selection of a service 626 to stop or reduce memory 642 based on a priority 628 of the service 626 and/or a current operation 630. For example, if a current operation 630 is for an image capturing device of the AR wearable device 622 to capture an image, then a send service 614, which is configured to send the image to a paired client device 102, is not selected for stopping or reducing the memory 642. In another example, a low priority 628 service 626 such as a lock screen service 626 with a priority 628 of “2” is stopped or memory is reduced before a higher priority 628 camera service 626 with a priority 628 of “8” is stopped or memory is reduced.

The service manager 602 determines the status of the service 626. The status of the service 626 is one of: “Service visibility changes” 908, “Service is running” 920, or “Service resides in background” 946. The “Service visibility changes” 908 indicates that the user interface (UI) visibility has changed such as the UI for the service 626 is no longer displayed on a display of the AR wearable device 622. So, the service manager 602 is to “trim memory UI hidden” 910 based on the service 626 being in a status where the UI is not being displayed. The service manager 602 determines to stop services 626 based on the criterion C1 912 to “release non-UI” services 626. For example, service manager 602 may stop a sound service 914 or camera service 916 that are not currently displaying its UI. In some examples, the service manager 602 receives the trim memory 902 signal from the OS that indicates a service 626 has a “service visibility change” 908. The service manager 602 then may stop the service 626.

If the status of the service 626 is “Service is Running” 920, then there are three choices for trimming memory 642. “Trim memory running moderate” 922 indicates the service manager 602 is to trim memory 642 based on the OS having a moderate amount of memory. The service manager 602 uses criterion C2 928, which is to stop or release services 626 that are easier to recover. For example, the service manager 602 stops a bug report 924 service or OTA 926 service. Both the bug report 924 service and the OTA 926 service require few resources to run again.

“Trim memory running low” 930 indicates the service manager 602 is to trim memory 642 based on the OS running low of memory 642. The service manager 602 selects services 626 to stop based on criterion C3 932, which is to release unused services. For example, the service manager 602 selects a sound service 934 or camera service 936 to release since neither of them have been used recently. The service manager 602 may maintain or have access to an indication of how long a service 626 has been idle or not used.

“Trim memory critical” 938 indicates that the service manager 602 is to trim memory 642 based on the OS being critically low of memory 642. The service manager 602 stops services 626 based on the criterion C4 940, which is to stop services 626 that are non-critical services 626. For example, portions of the service 626 that provide a telemetry service 942 or camera service 944 may be stopped based on the services 626 being non-critical services 626.

If the status of the service 626 is “Service Resides in Background” 946, then there are three choices for an amount of memory 642 to be trimmed. “Trim memory background” 948 indicates the service manager 602 is to trim memory 642 based on the memory 642 that is being used for background services 626. The service manager 602 determines which services 626 to stop based on the criterion C5 956, which is to stop services 626 that are easier to recover. For example, the service manager 602 stops the bug report 950 service, OTA 952 service, and the audio service 954 based on the services 626 being in the background and being easy to recover.

“Trim memory moderate” 958 indicates the service manager 602 is to trim memory 642 based on the OS running moderately low of memory 642. The service manager 602 bases the stopping services 626 on criterion C6 960, which is to stop services 626 that are least recently used. For example, the service manager 602 stops the sound service 962 and/or the camera service 964. The service manager 602 has access to a least recently used (LRU) list of the services 626 and may stop a percentage of the services 626 that are running but have not been used recently. The percentage may be 10 to 90 percent, in accordance with some examples.

“Trim memory complete” 966 indicates the service manager 602 is to trim memory 642 based on the OS being very low of memory 642. The service manager 602 selects services 626 to stop based on criterion C7 968, which is to stop non-essential services 626. For example, the service manager 602 stops the telemetry service 970 and/or COF service 972.

In some examples, the service manager 602 intercepts a trim memory 902 request intended for a service 626. The service manager 602 sends the trim memory 902 request to the service 626, in accordance with some examples.

FIG. 10 is a perspective view of a wearable electronic device in the form of glasses 1000, in accordance with some examples. The glasses 1000 are an article of eyewear including electronics, which operate within a network system for communicating image and video content. In some examples, the wearable electronic device is termed AR glasses or a head mounted display (HMD). The glasses 1000 can include a frame 1032 made from any suitable material such as plastic or metal, including any suitable shape memory alloy. The frame 1032 can have a front piece 1033 that can include a first or left lens, display, or optical element holder 1036 and a second or right lens, display, or optical element holder 1037 connected by a bridge 1038. The front piece 1033 additionally includes a left end portion 1041 and a right end portion 1042. A first or left optical element 1044 and a second or right optical element 1043 can be provided within respective left and right optical element holders 1036, 1037. Each of the optical elements 1043, 1044 can be a lens, a display, a display assembly, or a combination of the foregoing. In some examples, for example, the glasses 1000 are provided with an integrated near-eye display mechanism that enables, for example, display to the user of preview images for visual media captured by cameras 1069 of the glasses 1000.

The frame 1032 additionally includes a left arm or temple piece 1046 and a right arm or temple piece 1047 coupled to the respective left and right end portions 1041, 1042 of the front piece 1033 by any suitable means such as a hinge (not shown), so as to be coupled to the front piece 1033, or rigidly or fixedly secured to the front piece 1033 so as to be integral with the front piece 1033. Each of the temple pieces 1046 and 1047 can include a first portion 1051 that is coupled to the respective end portion 1041 or 1042 of the front piece 1033 and any suitable second portion 1052, such as a curved or arcuate piece, for coupling to the ear of the user. In one example, the front piece 1033 can be formed from a single piece of material, so as to have a unitary or integral construction. In one example, the entire frame 1032 can be formed from a single piece of material so as to have a unitary or integral construction.

The glasses 1000 include a computing device, such as a computer 1061, which can be of any suitable type so as to be carried by the frame 1032 and, in one example, of a suitable size and shape, so as to be at least partially disposed in one or more of the temple pieces 1046 and 1047. In one example, the computer 1061 has a size and shape similar to the size and shape of one of the temple pieces 1046, 1047 and is thus disposed almost entirely if not entirely within the structure and confines of such temple pieces 1046 and 1047.

In one example, the computer 1061 can be disposed in both of the temple pieces 1046, 1047. The computer 1061 can include one or more processors with memory, wireless communication circuitry, and a power source. The computer 1061 comprises low-power circuitry, high-speed circuitry, location circuitry, and a display processor. Various other examples may include these elements in different configurations or integrated together in different ways. Additional details of aspects of the computer 1061 may be implemented as described with reference to the description that follows.

The computer 1061 additionally includes a battery 1062 or other suitable portable power supply. In one example, the battery 1062 is disposed in one of the temple pieces 1046 or 1047. In the glasses 1000 shown in FIG. 10, the battery 1062 is shown as being disposed in the left temple piece 1046 and electrically coupled using a connection 1074 to the remainder of the computer 1061 disposed in the right temple piece 1047. One or more input and output devices can include a connector or port (not shown) suitable for charging a battery 1062 accessible from the outside of the frame 1032, a wireless receiver, transmitter, or transceiver (not shown), or a combination of such devices.

The glasses 1000 include digital cameras 1069. Although two cameras 1069 are depicted, other examples contemplate the use of a single or additional (i.e., more than two) cameras 1069. For ease of description, various features relating to the cameras 1069 will be described further with reference to only a single camera 1069, but it will be appreciated that these features can apply, in suitable examples, to both cameras 1069.

In various examples, the glasses 1000 may include any number of input sensors or peripheral devices in addition to the cameras 1069. The front piece 1033 is provided with an outward-facing, forward-facing, front, or outer surface 1066 that faces forward or away from the user when the glasses 1000 are mounted on the face of the user, and an opposite inward-facing, rearward-facing, rear, or inner surface 1067 that faces the face of the user when the glasses 1000 are mounted on the face of the user. Such sensors can include inward-facing video sensors or digital imaging modules such as cameras 1069 that can be mounted on or provided within the inner surface 1067 of the front piece 1033 or elsewhere on the frame 1032 so as to be facing the user, and outward-facing video sensors or digital imaging modules such as the cameras 1069 that can be mounted on or provided with the outer surface 1066 of the front piece 1033 or elsewhere on the frame 1032 so as to be facing away from the user. Such sensors, peripheral devices, or peripherals can additionally include biometric sensors, location sensors, accelerometers, or any other such sensors. In some examples, projectors (not illustrated) are used to project images on the inner surface of the optical elements 1043, 1044 (or lenses) to provide a mixed reality or augmented reality experience for the user of the glasses 1000.

The glasses 1000 further include an example of a camera control mechanism or user input mechanism comprising a camera control button mounted on the frame 1032 for haptic or manual engagement by the user. The camera control button provides a bi-modal or single-action mechanism in that it is disposable by the user between only two conditions, namely an engaged condition and a disengaged condition. In this example, the camera control button is a push button that is by default in the disengaged condition, being depressible by the user to dispose it to the engaged condition. Upon release of the depressed camera control button, it automatically returns to the disengaged condition.

In other examples, the single-action input mechanism can instead be provided by, for example, a touch-sensitive button comprising a capacitive sensor mounted on the frame 1032 adjacent to its surface for detecting the presence of a user's finger, to dispose the touch-sensitive button to the engaged condition when the user touches a finger to the corresponding spot on the outer surface 1066 of the frame 1032. It will be appreciated that the above-described camera control button and capacitive touch button are but two examples of a haptic input mechanism for single-action control of the camera 1069, and that other examples may employ different single-action haptic control arrangements.

The computer 1061 is configured to perform the methods described herein. In some examples, the computer 1061 is coupled to one or more antennas for reception of signals from a GNSS and circuitry for processing the signals where the antennas and circuitry are housed in the glasses 1000. In some examples, the computer 1061 is coupled to one or more wireless antennas and circuitry for transmitting and receiving wireless signals where the antennas and circuitry are housed in the glasses 1000. In some examples, there are multiple sets of antennas and circuitry housed in the glasses 1000. In some examples, the antennas and circuitry are configured to operate in accordance with a communication protocol such as Bluetooth™, Low-energy Bluetooth™, IEEE 802, IEEE 802.11az/be, and so forth. In some examples, PDR sensors housed in glasses 1000 and coupled to the computer 1061. In some examples, the glasses 1000 are VR headsets where optical elements 1043, 1044 are opaque screens for displaying images to a user of the VR headset. In some examples, the computer 1061 is coupled to user interface elements such as slide or touchpad 1076 and button 1078. A long press of button 1078 resets the glasses 1000. The slide or touchpad 1076 and button 1078 are used for a user to provide input to the computer 1061 and/or other electronic components of the glasses 1000. The glasses 1000 include one or more microphones 1082 that are coupled to the computer 1061. The glasses 1000 include one or more gyroscopes 1080.

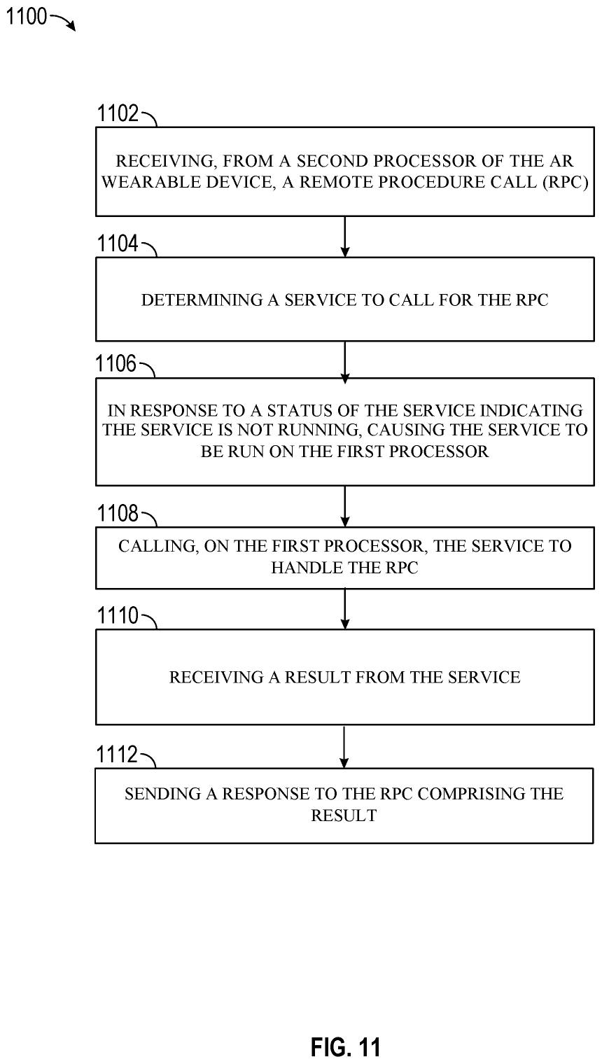

FIG. 11 illustrates a method 1100 for a service manager on a wearable device, in accordance with some examples. The method 1100 begins at operation 1102 with receiving, from a second processor of the AR wearable device, an RPC. For example, referring to FIG. 7, request (RPC) 716 is received from processor 1 712 by processor 2 722. The method 1100 continues at operation 1104 with determining a service to call for the RPC. For example, the add to queue 723 operations of FIG. 7 determines a service 626 for the request (RPC) 716.

The method 1100 continues at operation 1106 with in response to a status of the service indicating the service is not running, causing the service to be run on the first processor. For example, if the service 626 of FIG. 7 has a status that indicates it is not running, then the service manager 602 performs the operation of starting service 728 to start the service 626 indicated in the request (RPC) 716. The method 1100 continues at operation 1108 with calling, on the first processor, the service to handle the RPC. For example, the service manager 602 performs the operation of service call 732 to call the service 626 indicated in the request (RPC) 716 and may pass any parameters indicated in the request (RPC) 716 to the service 626.

The method 1100 continues at operation 1110 with receiving a result from the service. For example, the service 626 provides a result 736 to the service manager 602. The method 1100 continues at operation 1112 with sending a response to the RPC comprising the result. For example, the service manger 602 sends the response (RPC) 718 to the processor 1 712, which routes response 720 by sending the response 708 to a coupled client device 102 over or via BLE 704.

The method 1100 may include one or more additional operations. Operations of method 1100 may be performed in a different order. One or more of the operations of method 1100 may be optional. The method 1100 may be performed by the client device 102, AR wearable device 622, glasses 1000, or another electronic device. Portions of the functionality may be performed on a server computer or host computer. For example, glasses 1000 may be coupled to a host client device 102 or application server 114 where one or more of the operations are performed.

Machine Architecture

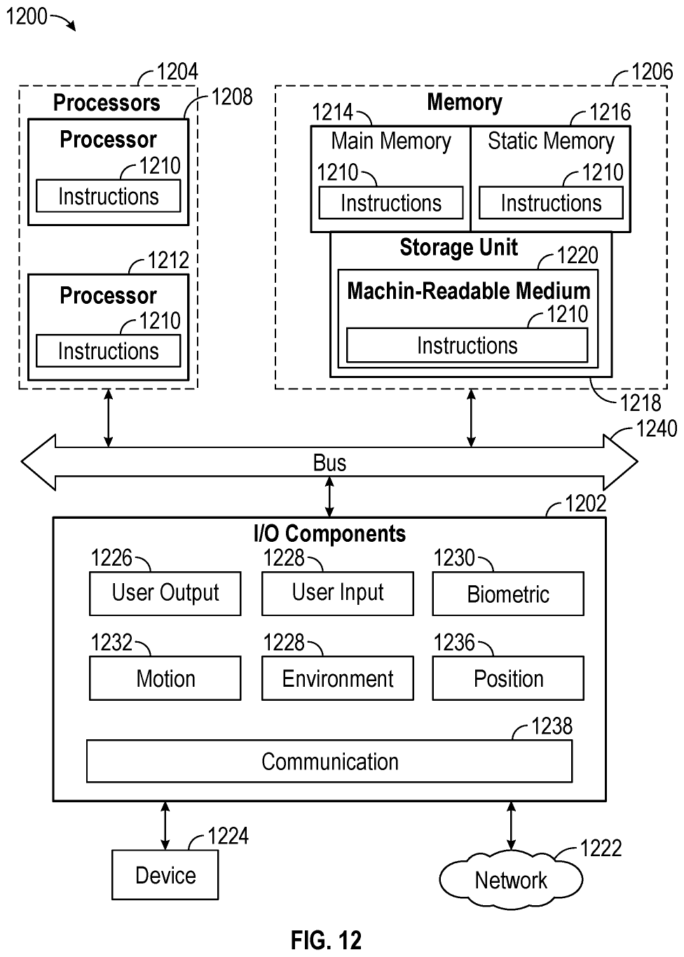

FIG. 12 is a diagrammatic representation of the machine 1200 within which instructions 1210 (e.g., software, a program, an application, an applet, an app, or other executable code) for causing the machine 1200 to perform any one or more of the methodologies discussed herein may be executed. For example, the instructions 1210 may cause the machine 1200 to execute any one or more of the methods described herein. The instructions 1210 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1210, sequentially or otherwise, that specify actions to be taken by the machine 1200. Further, while only a single machine 1200 is illustrated, the term “machine” shall also be taken to include a collection of machines that individually or jointly execute the instructions 1210 to perform any one or more of the methodologies discussed herein. The machine 1200, for example, may comprise the client device 102 or any one of a number of server devices forming part of the messaging server system 108. In some examples, the machine 1200 may also comprise both client and server systems, with certain operations of a particular method or algorithm being performed on the server-side and with certain operations of the particular method or algorithm being performed on the client-side.

The machine 1200 may include processors 1204, memory 1206, and input/output I/O components 1202, which may be configured to communicate with each other via a bus 1240. In an example, the processors 1204 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1208 and a processor 1212 that execute the instructions 1210. The term “processor” is intended to include multi-core processors that may comprise two or more independent processors (sometimes referred to as “cores”) that may execute instructions contemporaneously. Although FIG. 12 shows multiple processors 1204, the machine 1200 may include a single processor with a single-core, a single processor with multiple cores (e.g., a multi-core processor), multiple processors with a single core, multiple processors with multiples cores, or any combination thereof.

The memory 1206 includes a main memory 1214, a static memory 1216, and a storage unit 1218, both accessible to the processors 1204 via the bus 1240. The main memory 1206, the static memory 1216, and storage unit 1218 store the instructions 1210 embodying any one or more of the methodologies or functions described herein. The instructions 1210 may also reside, completely or partially, within the main memory 1214, within the static memory 1216, within machine-readable medium 1220 within the storage unit 1218, within at least one of the processors 1204 (e.g., within the Processor's cache memory), or any suitable combination thereof, during execution thereof by the machine 1200.

The I/O components 1202 may include a wide variety of components to receive input, provide output, produce output, transmit information, exchange information, capture measurements, and so on. The specific I/O components 1202 that are included in a particular machine will depend on the type of machine. For example, portable machines such as mobile phones may include a touch input device or other such input mechanisms, while a headless server machine will likely not include such a touch input device. It will be appreciated that the I/O components 1202 may include many other components that are not shown in FIG. 12. In various examples, the I/O components 1202 may include user output components 1226 and user input components 1228. The user output components 1226 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1228 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1202 may include biometric components 1230, motion components 1232, environmental components 1234, or position components 1236, among a wide array of other components. For example, the biometric components 1230 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1232 include acceleration sensor components (e.g., accelerometer), gravitation sensor components, rotation sensor components (e.g., gyroscope).

The environmental components 1234 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client device 102 may have a camera system comprising, for example, front cameras on a front surface of the client device 102 and rear cameras on a rear surface of the client device 102. The front cameras may, for example, be used to capture still images and video of a user of the client device 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client device 102 may also include a 360° camera for capturing 360° photographs and videos.

Further, the camera system of a client device 102 may include dual rear cameras (e.g., a primary camera as well as a depth-sensing camera), or even triple, quad or penta rear camera configurations on the front and rear sides of the client device 102. These multiple cameras systems may include a wide camera, an ultra-wide camera, a telephoto camera, a macro camera and a depth sensor, for example.

The position components 1236 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1202 further include communication components 1238 operable to couple the machine 1200 to a network 1222 or devices 1224 via respective coupling or connections. For example, the communication components 1238 may include a network interface Component or another suitable device to interface with the network 1222. In further examples, the communication components 1238 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 1224 may be another machine or any of a wide variety of peripheral devices (e.g., a peripheral device coupled via a USB).

Moreover, the communication components 1238 may detect identifiers or include components operable to detect identifiers. For example, the communication components 1238 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1238, such as location via Internet Protocol (IP) geolocation, location via Wi-Fi® signal triangulation, location via detecting an NFC beacon signal that may indicate a particular location, and so forth.

The various memories (e.g., main memory 1214, static memory 1216, and memory of the processors 1204) and storage unit 1218 may store one or more sets of instructions and data structures (e.g., software) embodying or used by any one or more of the methodologies or functions described herein. These instructions (e.g., the instructions 1210), when executed by processors 1204, cause various operations to implement the disclosed examples.

The instructions 1210 may be transmitted or received over the network 1222, using a transmission medium, via a network interface device (e.g., a network interface component included in the communication components 1238) and using any one of several well-known transfer protocols (e.g., hypertext transfer protocol (HTTP)). Similarly, the instructions 1210 may be transmitted or received using a transmission medium via a coupling (e.g., a peer-to-peer coupling) to the devices 1224.

### Software Architecture

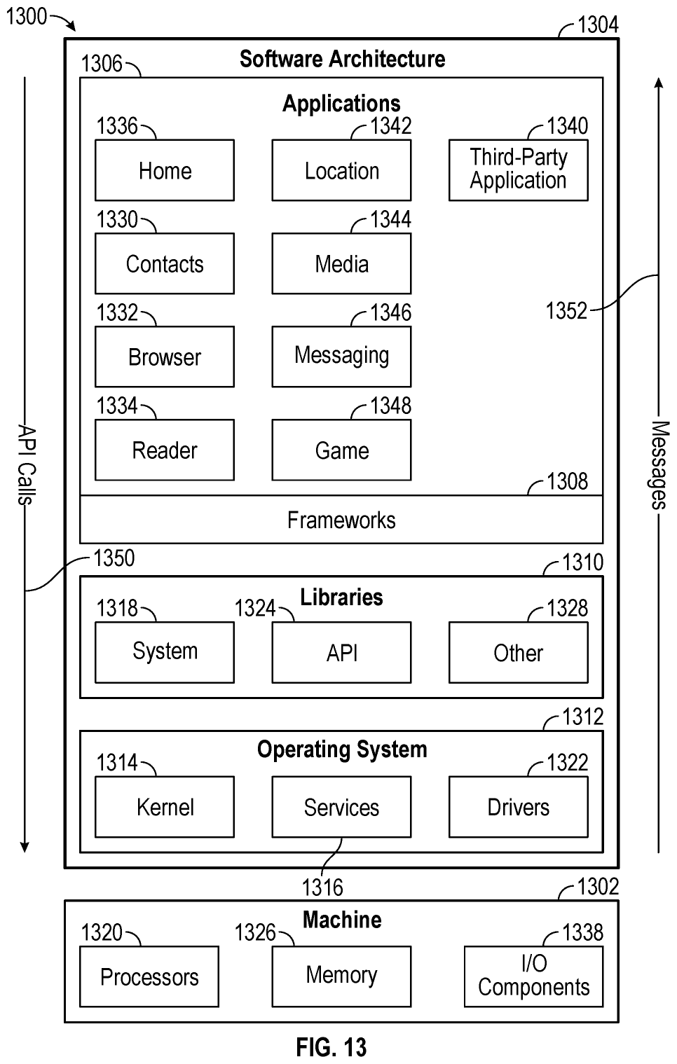

FIG. 13 is a block diagram 1300 illustrating a software architecture 1304, which can be installed on any one or more of the devices described herein. The software architecture 1304 is supported by hardware such as a machine 1302 that includes processors 1320, memory 1326, and I/O components 1338. In this example, the software architecture 1304 can be conceptualized as a stack of layers, where each layer provides a particular functionality. The software architecture 1304 includes layers such as an operating system 1312, libraries 1310, frameworks 1308, and applications 1306. Operationally, the applications 1306 invoke API calls 1350 through the software stack and receive messages 1352 in response to the API calls 1350.

The operating system 1312 manages hardware resources and provides common services. The operating system 1312 includes, for example, a kernel 1314, services 1316, and drivers 1322. The kernel 1314 acts as an abstraction layer between the hardware and the other software layers. For example, the kernel 1314 provides memory management, processor management (e.g., scheduling), component management, networking, and security settings, among other functionality. The services 1316 can provide other common services for the other software layers. The drivers 1322 are responsible for controlling or interfacing with the underlying hardware. For instance, the drivers 1322 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1310 provide a common low-level infrastructure used by the applications 1306. The libraries 1310 can include system libraries 1318 (e.g., C standard library) that provide functions such as memory allocation functions, string manipulation functions, mathematic functions, and the like. In addition, the libraries 1310 can include API libraries 1324 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1310 can also include a wide variety of other libraries 1328 to provide many other APIs to the applications 1306.

The frameworks 1308 provide a common high-level infrastructure that is used by the applications 1306. For example, the frameworks 1308 provide various graphical user interface (GUI) functions, high-level resource management, and high-level location services. The frameworks 1308 can provide a broad spectrum of other APIs that can be used by the applications 1306, some of which may be specific to a particular operating system or platform.

In an example, the applications 1306 may include a home application 1336, a contacts application 1330, a browser application 1332, a reader application 1334, a location application 1342, a media application 1344, a messaging application 1346, a game application 1348, and a broad assortment of other applications such as a third-party application 1340. The applications 1306 are programs that execute functions defined in the programs. Various programming languages can be employed to create one or more of the applications 1306, structured in a variety of manners, such as object-oriented programming languages (e.g., Objective-C, Java, or C++) or procedural programming languages (e.g., C or assembly language). In a specific example, the third-party application 1340 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1340 can invoke the API calls 1350 provided by the operating system 1312 to facilitate functionality described herein.

Processing Components

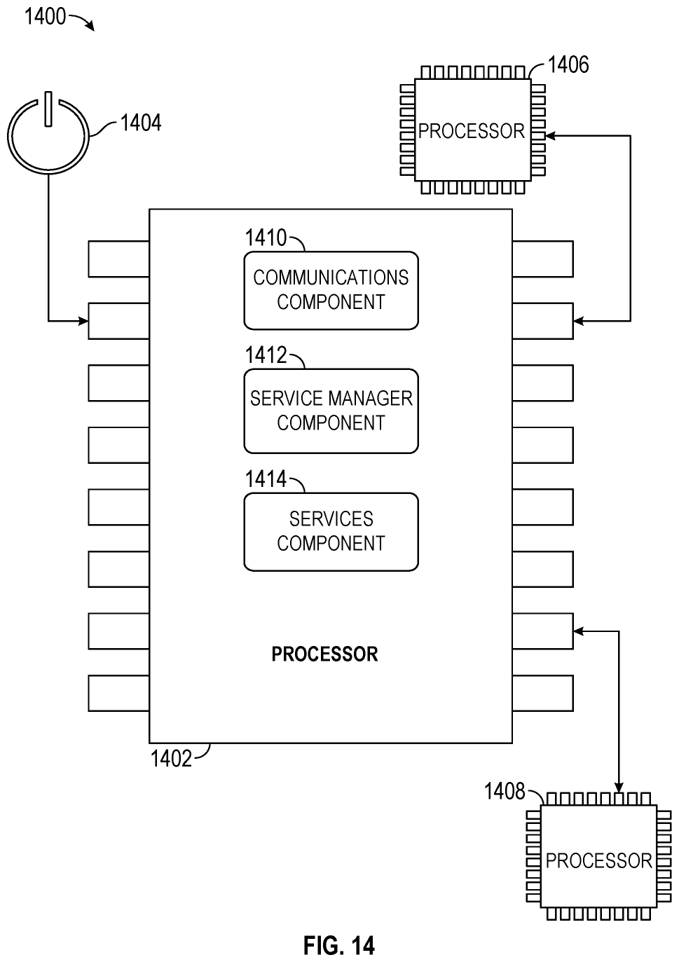

Turning now to FIG. 14, there is shown a diagrammatic representation of a processing environment 1400, which includes a processor 1402, a processor 1406, and a processor 1408 (e.g., a GPU, CPU or combination thereof).

The processor 1402 is shown to be coupled to a power source 1404, and to include (either permanently configured or temporarily instantiated) modules, namely a communications component 1410, a service manager component 1412, and a services component 1414. The communications component 1410 is invoked to process communications between the AR wearable device 622 and the client device 102 or backend 644. For example, the BLE RPC handler 710 is configured to communicated in accordance with BLE 704. In another example, the notification service 812 is configured to operate in accordance with HTTP 804.

The service manager component 1412 is configured to manage a memory 642 and services 626. For example, service manager 602 remains in memory 642 and listens for requests 634 for services 626 and determines which services 626 to stop and run.

The services component 1414 runs and stops services 626 based on commands from the service manager component 1412. For example, the services component 1414 will terminate a process that is running the settings service 610 in response to a command by the service manager 602 to terminate the settings service 610. As illustrated, the processor 1402 is communicatively coupled to both the processor 1406 and the processor 1408.

### Glossary

Certain examples are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example examples, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, an AR glasses, a VR glasses, an AR wearable device, a desktop computer, a laptop, a portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method performed on a first processor of a wearable device, the method comprising:
receiving, from a second processor of the wearable device, a remote procedure call (RPC);
determining a service to call for the RPC;
in response to a status of the service indicating the service is not running, causing the service to be run on the first processor;
calling, on the first processor, the service to handle the RPC;
receiving a result from the service;
sending a response to the RPC comprising the result.

2. The method of claim 1 wherein the service is a first service, the status is a first status, and wherein the method further comprises:
receiving, from a backend device via a wireless communication protocol, a notification to run a second service; and
in response to a second status of the second service indicating the second service is not running, causing the second service to run on the first processor.

3. The method of claim 1 wherein the service is a first service, the status is a first status, and wherein the method further comprises:
receiving, from the first processor, an indication of a request for a second service;
in response to a second status of the second service indicating the second service is not running, causing the second service to run on the first processor; and
calling, on the first processor, the second service to handle the request.

4. The method of claim 1 further comprising:
receiving, by the second processor, the RPC from a user device via a wireless communication protocol.

5. The method of claim 1 further comprising:
receiving from an operating system of the wearable device a signal to trim memory for the service; and
passing, to the service, the signal to trim memory.

6. The method of claim 1 wherein the service is a first service, and wherein the method further comprises:
in response to an indication that a user interface of a second service is not visible on a display of the wearable device, stopping the second service.

7. The method of claim 1 further comprising:
running one or more non-critical services; and
in response to an indication that an operating system of the wearable device requests that memory usage be trimmed, stopping one or more of the one or more non-critical services.

8. The method of claim 1 wherein the service is a first service, the status is a first status, and wherein the method further comprises:
running a second service, wherein the first service comprises a first priority, the second service comprises a second priority, and the first priority is greater than the second priority; and
in response to an indication that an operating system of the wearable device requests that memory usage be trimmed or determining to trim memory, stopping the second service based on the first priority being greater than the second priority.

9. The method of claim 1 wherein the service is a first service, the status is a first status, and wherein the method further comprises:
running a second service, wherein a current operation comprises the second service and not the first service; and
in response to an indication that an operating system of the wearable device requests that memory usage be trimmed or determining to trim memory, stopping the first service based on the current operation comprising the second service.

10. The method of claim 1 further comprising:
in response to receiving a first trim memory request from an operating system of the wearable device or determining to trim memory, sending a second trim memory request to the service.

11. The method of claim 1 further comprising:
running a plurality of services, the plurality of services comprising the service;
maintaining a least recently used list of the plurality of services; and
in response to receiving a trim memory request from an operating system of the wearable device or determining to trim memory, stopping one or more of the plurality of services based on the least recently used list.

12. The method of claim 1 further comprising:
running a first plurality of services, the first plurality of services comprising the service, wherein the first plurality of services are essential services;
running a second plurality of service, wherein the second plurality of service are non-essential services; and
in response to receiving a trim memory request from an operating system of the wearable device or determining to trim memory, stopping one or more of the second plurality of services.

13. The method of claim 1 wherein the service is a first service, the status is a first status, and wherein the method further comprises:
receiving, from the first processor, an indication of an event;
determining a second service to call for the event;
in response to a second status of the second service indicating the second service is not running, causing the second service to be run on the first processor; and
calling, on the first processor, the second service to handle the event.

14. The method of claim 13 wherein the event is a change in a state of the wearable device or input from a user of the wearable device, and wherein the wearable device is an augmented reality (AR) wearable device.

15. The method of claim 1 wherein the service is a first service, the status is a first status, the RPC is a first RPC and wherein the method further comprises:
receiving, from a second processor of the wearable device, a second RPC;
determining a second service to call for the second RPC; and
in response to a second status of the second service indicating the service is not running, and a determination to queue the second RPC, queuing the second RPC.

16. A wearable device comprising:
a first processor; and
a memory storing instructions that, when executed by the processor, configure the wearable device to perform operations comprising:
receiving, from a second processor of the wearable device, a remote procedure call (RPC);
determining a service to call for the RPC;
in response to a status of the service indicating the service is not running, causing the service to be run on the first processor;
calling, on the first processor, the service to handle the RPC;
receiving a result from the service; and
sending a response to the RPC comprising the result.

17. The wearable device of claim 16 wherein the service is a first service, the status is a first status, and wherein the operations further comprise:
receiving, from a backend device via a wireless communication protocol, a notification to run a second service; and
in response to a second status of the second service indicating the second service is not running, causing the second service to run on the first processor.

18. The wearable device of claim 16 wherein the service is a first service, the status is a first status, and wherein the operations further comprise:
receiving, from the first processor, an indication of a request for a second service;
in response to a second status of the second service indicating the second service is not running, causing the second service to run on the first processor; and
calling, on the first processor, the second service to handle the request.

19. A non-transitory computer-readable storage medium that stores instructions for execution by a first processor of wearable device, the instructions to configure the first processor to:
receive, from a second processor of the wearable device, a remote procedure call (RPC);
determine a service to call for the RPC;
in response to a status of the service indicating the service is not running, cause the service to be run on the first processor;
call, on the first processor, the service to handle the RPC;
receive a result from the service; and
send a response to the RPC comprising the result.

20. The non-transitory computer-readable storage medium of claim 19 wherein the service is a first service, the status is a first status, and wherein the instructions further configure the first processor to:
receive, from a backend device via a wireless communication protocol, a notification to run a second service; and
in response to a second status of the second service indicating the second service is not running, cause the second service to run on the first processor.
